(19) United States
(12) Patent Application Publication
(10) Pub. No.: US 2002/0084914 A1
(43) Pub. Date: Jul. 4, 2002

(54) Revenue meter arrangement having sensors in mounting device

(76) Inventors: Philip L. Jackson, West Lafayette, IN (US); John T. Voisine, Lafayette, IN (US); Thomas P. Houck, Lafayette, IN (US)

Correspondence Address: Harold C. Moore, Maginot, Addison & Moore, Bank One Center/Tower, 111 Monument Circle, Suite 3000, Indianapolis, IN, 46204-5115, US

(21) Appl. No.: 09/900,740

(22) Filed: Jul. 6, 2001

Related U.S. Application Data
(63) Continuation-in-part of application No. 09/227,433, filed on Jan. 8, 1999, now Pat. No. 6,275,168.
Application No. 09/227,433 is a continuation-in-part of application No. 08/862,844, filed on May 23, 1997, now Pat. No. 5,933,004.

(51) Int. Cl. G08C 15/06; G08B 23/00

(52) U.S. Cl. 340/870.02

(57) ABSTRACT

An electricity meter assembly has a meter mounting device and a measurement meter. The meter mounting device is operable to receive power lines of a load being metered, and includes a sensor circuit. The sensor circuit is operably connected to the power lines, and is operable to generate measurement signals representative of voltage and current signals on the power lines. The measurement meter includes a measurement circuit operable to receive measurement signals and generate energy consumption data therefrom. The measurement meter further includes a device that communicates information relating to the energy consumption data. The measurement meter is operable to be removably coupled to the meter mounting device such that the measurement circuit is operably connected to the sensor circuit to received the measurement signals when the measurement meter is coupled to the meter mounting device.

### CROSS REFERENCE TO RELATED APPLICATION

This is a continuation-in-part of U.S. patent application Ser. No. 09/227,433, filed Jan. 8, 1999, which is a continuation-in-part of U.S. patent application Ser. No. 08/862,844, filed May 23, 1997.

### BACKGROUND OF THE INVENTION

The present invention relates generally to the field of metering devices, and in particular, to electrical utility revenue meters.

Electrical utility revenue meters, or simply revenue meters, are devices that, among other things, measure electrical energy consumed by a residence, factory, commercial establishment or other such facility. Electrical utilities rely on revenue meters for many purposes, including billing customers and tracking demand for electrical power. A common form of revenue meter comprises an inductive drive that rotates a spinning disk at an angular velocity proportional to the amount of power being consumed. The spinning disk drives mechanical counters that provided an indication of power consumed over time.

Over recent years, electronic meters have been developed that are replacing the spinning disk meter design in several applications. Electronic meters use electronic circuits to measure, quantify and display energy consumption information. In general, electronic meters may be divided into two portions, a sensor portion and a measurement portion. The sensor portion includes sensor devices that are connected to the electrical system of a facility, and more particularly, to the power lines. The sensor devices generate signals that are indicative of the voltage and current in the power lines. In general, the sensor portion of a revenue meter operates with the high voltages and currents that are present on the power lines.

The measurement portion of an electronic meter uses the signals generated by the sensor portion to determine watt-hours, VA, VAR and other information that quantifies the power consumed by the facility. The measurement portion typically also includes a display for displaying the power consumption information. In contrast to the sensor portion, the measurement circuit works with reduced or attenuated voltage and current signals that are compatible with electronic devices, and in particular, digital electronic devices.

Electricity meters, whether mechanical or electronic, must be installed at or near the physical location of the load that is being measured. For example, residential electricity meters are installed at the location at which a residence connects to the utility power lines. To this end, the electricity meter must be physically secured at the installation point, and must include electrical connections to the main electrical feeder(s) of the load being measured.

To this end, structures such as residential, commercial and industrial establishments have historically included meter mounting devices that allow for the installation of electricity meters. A typical meter mounting device includes an enclosure that supports and secures the meter physically. Within the meter mounting device are terminal assemblies that allow the meter to connect to the appropriate cables to carry out the electricity measurements. In particular, the meter mounting device often includes jaws that receive corresponding blades on the meter. The jaws are connected to the utility power lines as well as the feeder lines of the load. As a result, insertion of the meter blades into the jaws operably connects the meter to allow the meter to measure energy consumption.

In many meter installations, the connection between the utility power line and feeders to the load being measured is made through the electricity meter. In other words, if the meter is not present, the load does not receive electricity. Because all of electrical power to the load may be passed through the meter, the blades of the electricity meter must have substantial size.

Occasionally, revenue meters can malfunction or suffer damage through external forces and require repair or replacement. Because the electrical connection between the utility and the load is made through the meter, repair or replacement of many commonly-used revenue meters presently require an interruption in the electrical power to the facility being metered. In general, power service interruptions are extremely undesirable from the electrical utilities' perspective because they reduce customer satisfaction. Accordingly, there exists a need for a revenue meter that may be repaired or replaced without interrupting power service to the facility being metered.

Another problem that has arisen due to the advent of electronic meters pertains to service upgrades. In general, electronic meters offer a wide variety of features that are facilitated by the incorporation of the digital electronics in the measurement portion. These features may include power demand monitoring, communications, and power line and meter diagnostics. Because these features are facilitated by the digital circuitry in the measurement portion of the meter, the services or functions available in an electronic-type revenue meter maybe altered by replacing digital circuit components in the measurement portion of the meter.

For example, consider a situation in which an electrical utility service provider installs several electronic meters without power demand monitoring because it is deemed unnecessary at the time of installation. A year later the same service provider may determine that it would be desirable to have the power demand monitoring capability in those meter installations. The installed electronic meters may, in theory, be upgraded to provide that capability typically by replacing portions of the electronic portion. The sensor portion components would not need to be replaced.

As a practical matter, however, it is often more convenient to replace the entire meter rather than the individual digital circuit components. In particular, custom replacement or addition of circuit elements on an existing meter is labor intensive and not cost justifiable. Accordingly, enhancement of the capabilities of the metering often requires replacement of the entire meter. Replacement of the entire meter, however, undesirably creates waste by forcing the replacement of relatively costly, and perfectly operable, sensor components.

A meter introduced by ABB Power T & D Company, Inc. (“ABB meter”) partially addresses this concern by providing a modular meter that includes a sensor portion and a removable measurement portion. The measurement portion may be removed from the sensor assembly and replaced with another measurement portion having enhanced functionality. The ABB meter, however, has significant drawbacks. For example, the measurement portion of the ABB meter can not be replaced while the sensor portion is connected to an electrical system of a facility because removal of the measurement portion would expose extremely dangerous voltages and currents to a human operator or technician. Thus, although the modular design allows for upgrades, the power to the facility must nevertheless be interrupted to perform such upgrades for safety purposes.

There exists a need, therefore, for a modular meter having modular components that may be removed or replaced without interruption to the electrical power service to the facility to which the meter is connected.

### SUMMARY OF THE INVENTION

The present invention overcomes the above stated needs, as well as others, by providing a meter mounting device that includes the current sensor devices located therein. By including the current sensor devices within the mounting device, the meter itself may include substantially only the measurement portion of an electronic meter. Replacement of such a meter would not necessarily interrupt service, and would not require replacement of the current sensor equipment. Thus, the replacement may be done conveniently and at substantially reduced material cost.

A first embodiment of the present invention is an electricity meter assembly that has a meter mounting device and a measurement meter. The meter mounting device is operable to receive power lines of a load being metered, and includes a sensor circuit. The sensor circuit is operably connected to the power lines, and is operable to generate measurement signals representative of voltage and current signals on the power lines. The measurement meter includes a measurement circuit operable to receive measurement signals and generate energy consumption data therefrom. The measurement meter further includes a device that communicates information relating to the energy consumption data. The measurement meter is operable to be removably coupled to the meter mounting device such that the measurement circuit is operably connected to the sensor circuit to received the measurement signals when the measurement meter is coupled to the meter mounting device.

A second embodiment of the present invention is a meter mounting device for use in connection with a measurement meter, the measurement meter including a measurement circuit operable to receive measurement signals and generate energy consumption data therefrom. The meter mounting device is operable to receive power lines of a load being metered. The meter mounting device includes a sensor circuit operably connected to the power lines, the sensor circuit operable to generate the measurement signals. The measurement signals are representative of voltage and current signals on the power lines. The meter mounting device is configured to allow the measurement meter to be removably coupled thereto such that the measurement circuit is operable to receive measurement signals from the sensor circuit when the measurement meter is coupled to the meter mounting device.

The above discussed features and advantages, as well as others, may readily be ascertained by those of ordinary skill in the art by reference to the following detailed description and accompanying drawings.

### BRIEF DESCRIPTION OF THE DRAWINGS

FIG. 1 shows an exploded perspective view of an exemplary embodiment of an electricity meter assembly meter according to the present invention;

FIG. 2 shows an exploded perspective view of the sensor assembly and the measurement meter of the meter assembly of FIG. 1;

FIG. 3 shows a schematic circuit diagram of the sensor assembly of the exemplary embodiment of the meter assembly of FIG. 1;

FIG. 4 shows an exemplary measurement circuit and associated display for use on the printed circuit board in the measurement module of FIGS. 1 and 2; and

FIG. 5 shows a perspective view of a second embodiment of a meter mounting device according to the present invention;

FIG. 6 shows a perspective view of the meter mounting device of FIG. 5 with the cover and interface removed;

FIG. 7 shows a plan view of the meter mounting device of FIG. 5 with the cover and interface removed; and

FIG. 8 shows a schematic diagram of the sensor circuit of the exemplary embodiment of the meter mounting device of FIG. 5.

### DETAILED DESCRIPTION

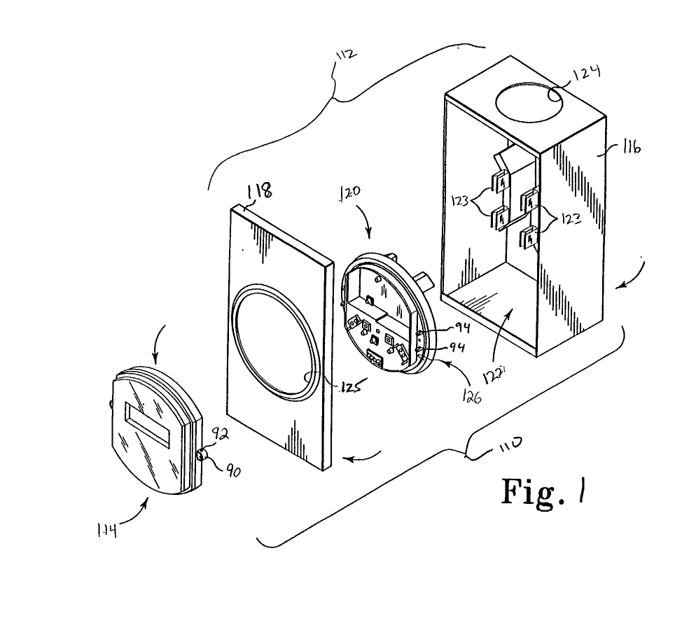

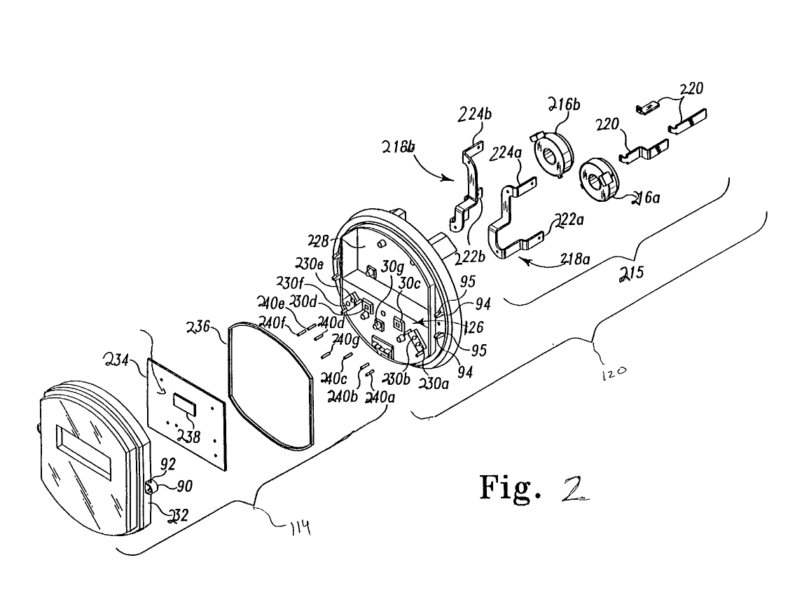

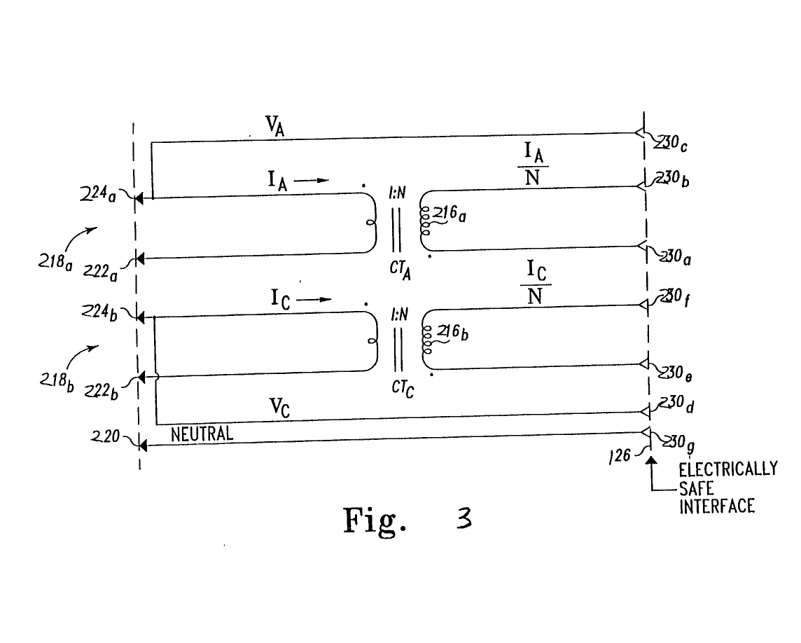

FIG. 1 shows a first embodiment of an exemplary electricity meter assembly 110 according to the present invention. The exemplary electricity meter assembly includes a meter mounting device 112 and a measurement meter 114. In general, the meter mounting device 112 of the embodiment of FIG. 1 includes a enclosure base 116, a cover 118, and a sensor assembly 120. The enclosure base 116, the cover 118, and a portion of the sensor assembly 120 cooperate to form an enclosure having an interior 122. The sensor assembly 120 includes a sensor circuit, not shown, but which is shown in FIGS. 2 and 3, discussed further below.

The embodiment shown in FIG. 1, as will be discussed further below, allows for replacement of the measurement meter 114 without replacement of the sensor circuit and without dismantling the meter mounting device 112. Accordingly, the meter functionality as embodied in the electronic circuits of the measurement meter 114 may be upgraded or replaced without the inconvenience or expense of removing and/or replacing the sensor circuit.

Moreover, if necessary, the sensor assembly 120 may be readily removed and/or replaced when the cover 118 is removed from the enclosure base 116. This allows for the flexibility of being able to remove the measurement meter 114 apart from the sensor assembly 120, as discussed above, while also enabling removal of both the sensor assembly 120 and the measurement meter 114 when circumstances warrant. For example, in some cases it is sufficient merely to replace the measurement meter 114 while in other cases, it may be desirable to replace the sensor assembly 120, or the combination of the measurement meter 114 and the sensor assembly 120. The embodiment of FIG. 1 facilitates all of the above mentioned replacement scenarios without necessarily requiring replacement of the measurement meter 114 and the sensor assembly 120 as a unit in all cases.

As shown in FIG. 1, the enclosure base 116 is box-like in structure having an opening for receiving the cover 118 and a cabling opening 124 for receiving the power lines of the electrical system being metered, not shown. It will be appreciated that the enclosure base 116 need not be box-like in structure, and that any other suitable shape may be used, as long as there is an opening for receiving a cooperating meter box cover and a cabling opening.

Within the interior 122 are located a plurality of jaws 123 constructed of electrically conductive material. When installed into a facility, the plurality of jaws 123 are electrically connected to the power lines of the electrical system of the facility. To this end, a plurality of terminals, not shown, are located within the interior 122 that are electrically coupled to the jaws 123. The terminals connect to the ends of the power line to complete the connection between the jaws 123 and the power lines.

It will be noted that the enclosure base 116 may suitably comprise any of a plurality of commercially available meter mounting boxes or enclosures. One of the advantages of the embodiment of the invention shown in FIG. 1 is that it illustrates how the present invention may be retrofitted into existing meter mounting enclosures. For example, the enclosure base 116 and cover 118 constitute a standard meter mounting box capable of receiving single piece meters in accordance with the prior art. In such prior art assemblies, a single piece meter was inserted so that it was partially disposed within the interior 122 and blades on the meter were received by the jaws 123. In accordance with the present invention, by contrast, the sensor assembly 120 forms a portion of the meter mounting device 112, in part, because the measurement meter 114 is removable therefrom. Thus, the sensor assembly 120 may be adapted to fit other meter enclosures such that the combination of those enclosures and the adapted sensor assembly 120 form a meter mounting device according to the present invention.

Further details of the sensor assembly 120 and the measurement meter 114 are shown in FIG. 2. In particular, FIG. 2 shows an exploded view of the sensor assembly 120 and the measurement meter 114 of the assembly 110 of FIG. 1.

The measurement meter 114 is constructed such that it may be removably coupled to the sensor assembly 120. The measurement meter 114 and the sensor assembly 120 cooperate to form a type of revenue meter known in the revenue metering industry as a 25S meter form. The meter form relates to the meter installation, for example, whether it is single phase or polyphase. In any event, it will be noted that the present invention is not limited to applications involving 25S meter forms, but may readily be incorporated into 2S, 3S, 4S, 8S/9S, 12S and other well known meter forms by those of ordinary skill in the art.

The sensor assembly 120 includes voltage and current sensors, which according to the exemplary embodiment described herein, include first and second current transformers 216a and 216b, respectively, first and second current coils 218a and 218b, respectively, and one or more neutral blades 220. The first current coil 218a includes first and second ends defining first and second current blades 222a and 224a, respectively, to be received by the jaws 123 located within the enclosure base 116. (See FIG. 1). The second current coil 218b likewise includes first and second ends defining first and second current blades 222b and 224b, respectively, to be received by the jaws 123. (See FIG. 1).

The first and second current transformers 216a and 216b, respectively, are preferably toroidal transformers having a substantially circular shape defined by a circular core. In the present embodiment, the first current transformer 216a has a turns ratio of N1 and the second current transformer has a turns ratio of N2. Using such toroidal current transformers, the first current coil 218a, when assembled, passes through the interior of the toroid of the first current transformer 216a.

Preferably, the current transformer 216a is arranged such that the axial dimension of the current transformer 216a is substantially parallel to the axial dimension of the sensor assembly 120. In other words, the current transformer 216a is horizontally-disposed within the sensor assembly 120. The second current transformer 216b and the second current coil 218b are preferably arranged in a similar manner within the sensor assembly 120. Accordingly, the second current transformer 216b is also horizontally disposed within the sensor assembly 120. The use of horizontally disposed toroidal current transformers reduces the thickness and thus reduces the size requirement of the enclosure base 116. In particular, if the transformers 216a and 216b were vertically disposed, the enclosure base 116 may require extra depth to contain the entire sensor circuit within the interior 122.

The sensor assembly 120 further includes an electrically safe interface 126. The electrically safe interface 126 comprises a first interconnecting means for connecting to the measurement meter 114. The electrically safe interface 126 also includes means for preventing physical contact of a human operator with potentially hazardous electrical signals present on at least a portion of the voltage and current sensors 215. Signal levels which are considered potentially hazardous are well-known. Different levels of potential hazard also exist. For example, signals capable of generating shock currents exceeding 70 milliamperes are possible burn hazards, while signals generating shock currents on the order of 300 milliamperes may constitute life threatening hazards. Furthermore, signals generating shock currents as low as 0.5 to 5 milliamperes are known to cause an involuntary startle reaction.

In revenue meters, at least some of the sensor devices carry such potentially hazardous electrical signals. Specifically, any portion of a meter that is electrically connected to the voltage and current signals from the power line constitutes a life threatening hazard. The electricity meter assembly 110 of the present invention isolates the voltage and current sensors by placing them within the meter mounting device 112 and providing the electrically safe interface 126. In the present embodiment, the current coils 218a and 218b are directly connected to the facility power line and therefore must be isolated. By contrast, the current transformers 216a and 216b, do not necessarily carry life threatening currents because, as discussed later, the current transformers 216a and 216b are not directly coupled to the facility power lines. Accordingly, depending on the highest level of expected current flowing through the current transformers 216a and 216b, the current transformers 216a and 216b may or may not carry potentially hazardous electrical signals. In any event, however, the electrically safe interface 126 preferably prevents human contact with all of the voltage and current sensors 215 as a safety measure.

In the present embodiment, the means for preventing physical contact includes a top plate 228, and a plurality of sockets 230a, 230b, 230c, 230d, 230e, 230f and 230g. Each of the sockets 230a through 230g defines an opening in the top plate 228. Other than the openings defined by the sockets 230a through 230g, the top plate 228 preferably forms a complete barrier or wall from the measurement meter 114 to the voltage and current sensors 215.

Alternatively, at a minimum, the top plate 228 operates to prevent human contact with the portions of the voltage and current sensors 215 that directly contact the power lines of the facility, and in particular, the current coils 218a and 218b.

In order to provide a complete barrier, the top plate 228 cooperates with the enclosure base 116 and the cover 118 that enclose the voltage and current sensors 215 from the side and bottom. In another alternative embodiment, the top plate 228 may be integrally coupled to the cover 118.

Referring again to FIG. 1, the sockets 230a through 230g and their corresponding openings are preferably configured to prevent a human operator from physically contacting the electrically conductive portions of the socket. In particular, the openings defined by the sockets 230a through 230g have sufficiently diminutive proportions to prevent contact of a standard test finger with the electrically conductive portions of the sockets 230a through 230g. A standard test finger is a mechanical device used in the electrical industry to determine whether an electrical connection socket is safe from accidental contact by a human finger. One standard test finger is described in Underwriter's Laboratory, Inc., Standard For Safety of Information Technology Equipment Including Electrical Equipment Business UL-1950 (Feb. 26, 1993).

In the present embodiment, the openings defined by the sockets 230a through 230g preferably have a first dimension, for example, the length, and a second dimension, for example, the width, wherein the first dimension has at least the same size as the second dimension, and the second dimension is less than ⅛ inch, thereby preventing substantial access of a human operator through the openings.

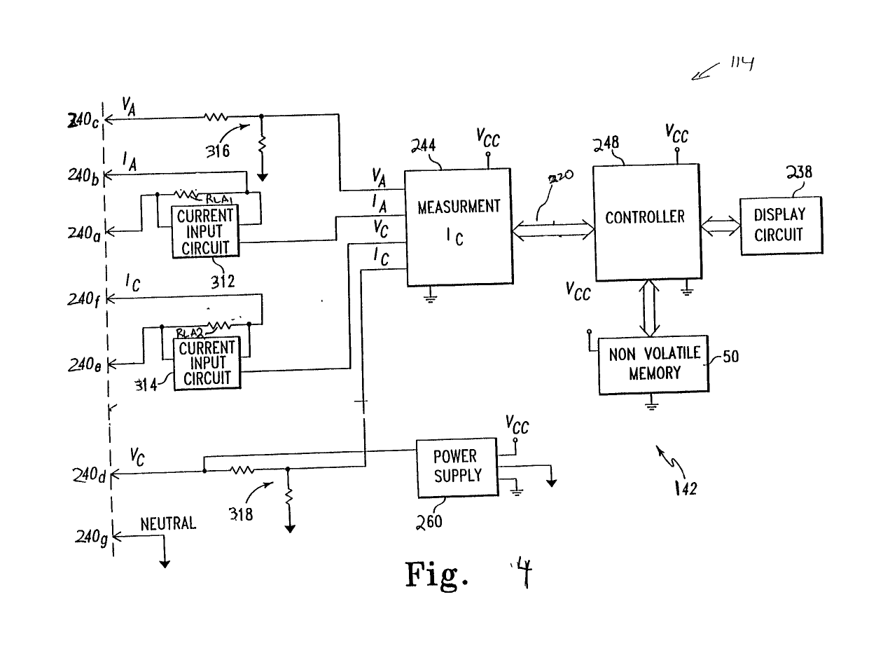

The measurement meter 114 comprises a face cover 232, a printed circuit board 234, and a gasket 236. The printed circuit board 234 includes a display 238, and a measurement circuit. FIG. 4, discussed further below, shows a circuit block diagram of a measurement circuit 142 that may readily be used as the measurement circuit on the printed circuit board 234 of FIG. A. The measurement circuit is operable to receive measurement signals and generate energy consumption data therefrom. The measurement circuit is operably connected to provide the energy consumption data to the display 238.

The measurement meter 114 further includes second interconnecting means operable to cooperate with first interconnecting means (on the sensor assembly 120 of the meter mounting device 112) to connect the measurement circuit of the printed circuit board 234 to the voltage and current sensors 215. For example, in the present embodiment, the measurement module 214 includes a plurality of plugs 240a through 240g that are received by the corresponding plurality of sockets 230a through 230g. The plurality of plugs 240a through 240g, when assembled, are electrically connected to the measurement circuit and physically connected to the printed circuit board 234.

Referring to FIGS. 1 and 2 together, the plurality of jaws 123 receive and provide electrical connection to the current coil blades 222a, 224a, 222b and 224b as well as the neutral blade or blades 220. The relationship of the jaws 123 and the blades 222a, 224a, 222b, and 224b also define the alignment of the sensor assembly 120 within the enclosure base 116. Once the blades 222a, 224a, 222b, and 224b are engaged with the plurality of jaws 123, the sensor assembly 120 is installed within the interior 122 of the meter mounting device 112. The cover 118 is then installed onto the housing 116. The cover 118 includes a meter opening 125 having a perimeter defined by the perimeter of the sensor assembly 120. Preferably, the perimeter of the meter opening 125 has substantially the same shape and is slightly smaller than the perimeter of the sensor assembly 120 such that the sensor assembly 120 cannot be removed when the cover 118 is engaged with the enclosure base 116, as is the case with existing meter mounting enclosures.

Once the cover 118 is installed, the measurement meter 114 in the present embodiment may be placed in engagement with the sensor assembly 120 through the meter opening 125 of the cover 118. When in engagement, the plugs 240a through 240g of the measurement meter 114 are electrically connected to the sockets 230a through 230g, respectively, of the sensor assembly 120. Once the measurement meter 114, the cover 118, the sensor assembly 120, and the enclosure base 116 are all assembled as described above, the electricity meter assembly 110 performs energy consumption measurements on the electrical system of the facility.

It is noted that the electricity meter assembly 110 preferably includes a means for preventing or inhibiting tampering. In particular, it is noted that if the measurement meter 114 is removed from the meter mounting device 112, the facility to which the meter mounting device 112 is connected will continue to receive electrical power service, but will not be charged for such power usage. The facility will not be charged for such power usage because the billing information is generally obtained from the energy consumption data in the measurement meter 114, and the measurement meter 114 can not generate any energy consumption data when it is removed from the sensor assembly 120 of the meter mounting device 112. Accordingly, a potential method of meter tampering is to remove the measurement meter 114 from the meter mounting device 120 for a few hours a day, or for one or more days, and then replace the measurement meter 114 before utility service provider personnel comes to read the meter.

One exemplary arrangement for preventing tampering is shown in FIGS. 1 and 2. In particular, the measurement meter 114 includes at least one, and preferably two opposing sealing members 90 which extend from opposing sides of the periphery of the measurement meter 114. For each sealing member 90, the sensor assembly 120 includes a pair of sealing ears 94 configured to receive each sealing member 90. The sealing member 90 has apertures 92 that are configured to align with apertures 95 on the sealing ears 94 when the measurement meter 114 is assembled onto the meter mounting device 112.

Once the measurement meter 114 is assembled onto the meter mounting device 112, a strand of pliable material, such as heavy gauge single strand copper, not shown, is passed through the apertures 92 and 95 and tied off. Then, a sealing wax or the like is applied to the pliable material such that the sealing wax must be removed to untie the pliable material to remove the pliable material from the apertures 92 and 95. As a result, utility service provider technicians can detect tampering by observing whether the wax seal has been removed.

In the alternative, other tamper protection devices may be employed, such as that described in U.S. patent application Ser. No. 09/667,888, filed Sep. 22, 2000, which is incorporated herein by reference. Additionally, electronic arrangements that detect and record removal of the measurement meter 114 may be employed, such as that described in U.S. patent application Ser. No. 09/345,696, filed Jun. 30, 1999, which is also incorporated herein by reference.

The configuration of the enclosure base 116 and cover 118 in FIG. 1 is a standard mounting device known as a ringless-type mounting device. It will be noted that the meter assembly 110 may readily configured out of a standard ring-type mounting device as well. A ring-type mounting device differs from the embodiment of FIG. 1 in that the sensor assembly 120 would be installed after the cover 118 is assembled onto the enclosure base 116. An annular ring would then be used to secure the sensor assembly 120 to the cover 118. To this end, the standard meter box cover for use in a ring-type mounting device includes a feature annularly disposed around the opening 125 which cooperates with the annular ring to engage and secure the sensor assembly 120 thereto.

As illustrated in FIG. 2, each of the current transformers 216a and 216b is arranged to be horizontally disposed, or in other words, each has an axial dimension that is parallel to the axial dimension of the face cover 232. The horizontally-disposed current transformers 216a and 216b provide significant space reduction advantages over vertically-disposed current transformers. In an electric utility meter, the horizontal footprint, for example, the length and width or diameter, is defined predominantly by the meter mounting equipment. For example, the plurality of jaws 123 of FIG. 1 define at least a minimum length and width, or in this case using a circular meter shape, a minimum diameter. Accordingly, the only space reduction that is practical in a meter is in the thickness or depth dimension. By disposing the current transformer 216b horizontally, the smallest dimension of the current transformer 216b is aligned in the only dimension of the meter that can be reduced. Accordingly, the horizontally-disposed current transformers 216a and 216b further reduce the overall size of the meter assembly 110.

As discussed above, the top plate 28 includes a plurality of sockets 230a, 230b, 230c, 230e, 230f and 230g. (See FIG. 2) Each socket 230x has an opening for receiving a corresponding plug 240x that is preferably slightly conical to allow for alignment adjustment of the plug 240d during assembly of the measurement meter 114 onto the sensor assembly 120. The socket 230x, which may suitably include a spring loaded terminal, is electrically connected one of the current coils 218a or 218b for the purposes of obtaining a corresponding phase voltage measurement, as discussed above in connection with FIG. 2.

Each plug 240x is connected to the circuit board 234 and is configured to be inserted the socket 230x. The socket 230 physically engages the plug 240x in such a manner as to provide an electrical connection therebetween. The plug 240x may suitably be an ordinary conductive pin.

Further detail regarding the sockets 230x, the plugs 240x, and an exemplary illustration of their structure and interrelationship may be found in U.S. Pat. No. 5,933,004, which is incorporated herein by reference.

It can thus be seen by reference to FIGS. 1 and 2, that the electrically safe interface 126 and/or the top plate 228, when fitted to the enclosure base 116 and the cover 118, provides a substantially solid barrier between a human operator or technician and the current and voltage sensing devices when the measurement meter 114 is removed for repair or replacement. The only openings are the openings that correspond to the sockets 230a through 230g to permit the plugs 240a through 240g to connect to the sockets 230a through 230g. Such openings are sufficiently small enough, and the sockets are sufficiently recessed within the openings, to prevent an operator from coming into direct contact with dangerous high voltages.

It will be appreciated that other interconnection means may be employed in the sensor assembly 120 and measurement meter 114 that will also provide an electrically safe interface. For example, wireless means may be used as the interconnection means. Such wireless means could provide voltage and current measurement signals from the sensor assembly 120 to the measurement meter 114. For example, the measurement meter 114 could include sensitive electric and magnetic field sensors that obtain voltage and current measurement information from electromagnetic radiation from the current coils 218a and 218b. Likewise, optical communication means may be used to provide measurement signal information from the sensor assembly 120 to the measurement meter 114. In any case, the electrically safe interface would typically include a barrier such as the top plate 228 that prevents physical access by a human operator to the current coils 218a and 218b and other dangerous portions of the sensor assembly 120 when the measurement meter 114 is removed.

To fully obtain the benefits of modularity, it is necessary to address calibration issues in the design of the meter assembly 110. Specifically, the meter mounting device 112 preferably has a calibration feature that allows it to be used in connection with any suitable measurement meter.

By contrast, in traditional meters where the sensor circuit and the measurement electronics are housed together as a single unit, the measurement circuit is often specifically calibrated for use with a particular voltage and current sensors. The reason for the specific calibration is that there can be large variations in signal response of each voltage and current sensors. In particular, the current sensing devices, such as current transformers, often have a widely variable signal response. The signal response of commonly available current transformers varies widely in both magnitude and phase response.

The signal response of such current transformers varies to a much greater extent than the energy measurement accuracy of the meter. In other words, while the current transformer signal response may vary as much as 10%, the overall accuracy of the meter is required to be much less than 10%. Accordingly, compensation must be made for the variance, or tolerance, of the current sensing devices to ensure that the ultimate energy measurement accuracy of the meter is within acceptable tolerances. The compensation is typically carried out in the prior art by adjusting or calibrating the measurement circuit during manufacture to account for the signal response characteristics of the current sensing devices that will be used in a particular meter unit. In other words, each measurement circuit is custom-calibrated for each meter.

The meter assembly 110, however, should not require such extensive unit-specific calibration. In other words, the meter mounting device 112 should be able to receive any of a plurality of measurement meters 114 without extensive calibration operations. Accordingly, referring again to FIG. 2, the sensor assembly 120 is pre-calibrated for modularity, such that the sensor assembly 120 may be coupled with any measurement meter 114 without requiring unit specific calibration of that measurement meter 114.

To this end, the sensor assembly 120, and specifically the voltage and current sensors 215 are pre-calibrated such that the voltage and current sensors 215 have a signal response within a tolerance of a predefined signal response that is no greater than the tolerance of the energy measurement accuracy of the meter assembly 110. The energy measurement accuracy of the meter assembly 110 may be defined as the accuracy of the measured energy consumption with respect to the actual energy consumption of the facility. Thus, if the tolerance of the energy measurement accuracy of the meter is required to be 0.5%, then the difference between the measured energy consumption and the actual energy consumption will not exceed 0.5%. In such a case, the tolerance of the signal response of the voltage and current sensors will be no more than, and typically substantially less than, 0.5%. As a result, the measurement meter 114 may readily be replaced with another measurement module without requiring specific calibration of the replacement measurement module.

The pre-calibration of the voltage and current sensors 215 may be accomplished using careful manufacturing processes. The primary source of variance in the signal response of the voltage and current sensors 215 is the signal response of the current transformers 216a and 216b. Generally available current transformers are prone to variance in both magnitude and phase angle signal response. Accordingly, pre-calibration involves using current transformers that are manufactured to perform within the required tolerances. As an initial matter, the current transformers 216a and 216b are manufactured using a high permeability core material, which reduces phase angle variance in the signal response. Moreover, the current transformers 216a and 216b are manufactured such that the actual number of turns is closely controlled. Close manufacturing control over the number of turns in the current transformers 216a and 216b produces sufficient consistency in the magnitude signal response to allow for interchangeability.

Alternatively, if controlling the number of turns during initial manufacturing is not desirable for cost reasons, then turns may be added or removed after manufacturing to achieve the desired signal response. For example, it may be more cost effective to buy wide tolerance commercially available current transformers and adjust the number of turns than to have sufficiently narrow tolerance current transformers specially manufactured.

Referring to FIG. 1, the servicing method described herebelow involves servicing the meter assembly 110, which is attached to the electrical system of the facility being metered, not shown. The types of servicing that may be accomplished by the following method include replacement of the measurement meter 114, repair of the measurement meter 114, and upgrading of the measurement meter 114. Because the components of the measurement meter 114 have higher complexity, a large proportion of the repair, replacement, and upgrade activity that is potentially possible with respect to the meter assembly 10 will involve only the measurement meter 114.

Typically, a technician first removes the measurement meter 114 from the meter mounting device 112 while the cover 118 remains installed over the sensor assembly 120 and onto the enclosure base 116. The measurement meter 14 operates having a first level of performance which requires replacement, repair, or upgrading, to a second level of performance. When the measurement meter 114 is removed, the sensor assembly 112 remains electrically connected to the electrical system of the facility, thereby allowing electrical power to be delivered to the facility.

The technician then replaces the measurement meter 114 with a replacement measurement module having a second level of performance. The replacement measurement module may suitably be the same measurement meter 114 wherein the technician has performed operations, such as repair, upgrade, or component replacement, to create the replacement module having the second level of performance.

An exemplary upgrade operation includes upgrading the measurement circuit 142 (see FIG. 4) to add features or capabilities. Revenue meters are often capable of sophisticated self-diagnostics, demand metering, time-of-use metering, and communication functionality. Sometimes, the owner of the facility being metered, or the utility providing the electrical power, desires to improve the capabilities of an existing meter. The capabilities may be improved by upgrading the measurement circuit 142. In such a case, the first level of performance defines the original performance capabilities and the second level of performance includes additional capabilities.

An exemplary repair operation may include the replacement of components. At times, one or more components of the measurement module 14 will fail, in which case, the first level of performance may be an inoperative level of performance. In such a case, the method described above further comprises performing an operation including replacing the at least one inoperative component to create the replacement module having a second level of performance.

In yet another exemplary operation, the above method may include replacing the measurement meter 114 with an entirely different measurement meter. If the measurement meter 114 requires repair or upgrade, it is often desirable to simply replace the measurement meter 114 having the first level of performance with another measurement module that has the second level of performance.

In any of the above described servicing scenarios, the power to the facility need not be interrupted. This provides a significant advantage over prior art methods of servicing meters that required a power service interruption to repair or replace meter components. The above method is not limited to use in connection with the exemplary embodiment described above, but is suitable for use in connection with any modular meter that includes an electrically safe interface between the module to be removed, for example, the measurement module, and the module that is not removed, for example, the sensor assembly.

Referring now to the circuit block diagram of the sensor assembly 120 of FIG. 3, the sockets 230a and 230b provide a connection to the first current transformer 216a, the sockets 230e and 230f provide a connection to the second current transformer 216b, the socket 230c provides a connection to the first current coil 218a, the socket 230d provides a connection to the second current coil 218b, and the socket 230g provides a connection to one or more of the neutral blades 220.

FIG. 4 shows a circuit block diagram of the measurement circuit 142 and associated display 238 for use in the measurement meter 114. The measurement circuit 142 includes a watt measurement integrated circuit (“IC”) 244, a microcontroller 248 and a non-volatile memory 250. Plugs 240a, 240b, 240c, 240d, 240e, and 240f are each connected to the watt measurement IC 244 through various input circuits. In particular, the plugs 240a and 240b are connected to the watt measurement IC 244 through a phase A current input circuit 312, the plugs 240e and 240f are connected to the watt measurement IC through a phase C current input circuit 314, the plug 240c is connected to the watt measurement IC 244 through a phase A voltage input circuit 316, and the plug 240d is connected to the watt measurement IC 244 through a phase C voltage input circuit 318.

The phase A current input circuit 312 is a device for obtaining a scaled signal indicative of the line current waveform on phase A. To this end, the phase A current input circuit 312 is connected across a line resistor RLA1 that is series connected between the plug 240a and the plug 240b. Likewise, the phase C current input circuit 314 is a device for obtaining a scaled signal indicative of the line current waveform on phase C. To this end, the phase C current input circuit 314 is connected across a line resistor RLA2 that is series connected between the plug 240e and the plug 240f. The outputs of the phase A and phase B current input circuits 312 and 314 are provided to the watt measurement IC 244.

The phase A voltage input circuit 316 is a voltage divider network tapped off of the connection to plug 240c. Similarly, the phase C voltage input circuit 318 is a voltage divider network tapped off of the connection to the plug 240d. The power supply 260 is a device the receives AC input line voltage and generates a dc bias voltage Vcc therefrom. Such power supplies are well known in the art. The power input to the power supply 260 is preferably tapped off of the connection to the plug 240d. The outputs of the phase A and phase C voltage input circuits 316 and 318 are provided to the watt measurement IC 244.

The watt measurement IC 244 is a device that receives measurement signals representative of voltage and current signals in an electrical system and generates energy consumption data therefrom. In the exemplary embodiment described herein, the watt measurement IC 244 may suitably be the conversion circuit 106 described in U.S. Pat. No. 6,112,158 or the conversion circuit 106 described in U.S. Pat. No. 6,112,159, both of which are assigned to the assignee of the present invention and incorporated herein by reference.

Alternatively, the watt measurement IC 244 may be replaced by one or more discrete circuits capable of carrying out the same function of generating energy consumption information from the voltage and current measurement signals. For example, the watt measurement IC 244 may suitably be replaced by the first and second watt measurement ICs 44 and 46 described in the U.S. Pat. No. 5,933,004, discussed above.

In any event, the watt measurement IC 244 is further operably connected to the microcontroller 248 through a bus structure 220. The bus structure 220 consists of one or more serial and or parallel busses that allow for data communication between the microcontroller 248 and the watt measurement IC 244. In general, the watt measurement IC 244 provides energy consumption data to the microcontroller 248 and the microcontroller 248 provides control and calibration data to the watt measurement IC 244.

The microcontroller 248 is further connected to the memory 250 and the display circuit 238.

In the operation of the exemplary meter assembly 110 illustrated in FIGS. 1-4, energy consumption measurements are carried out in the following manner. As discussed above, the present embodiment is intended for use with a wiring configuration commonly referred to in the industry as a three-wire network configuration. A three-wire network configuration, as is well known in the art, includes a phase A power line, a phase C power line, and a neutral line. The present invention, however, is in no way limited to use in a three wire network configuration. The concepts described herein may readily be implemented in meters used in other configurations, including single phase and other polyphase configurations.

In operation, the plurality of jaws 123 provide the phase A power line signal, in other words, the phase A voltage and current, across the blades 222a and 224a of the first current coil 218a (see FIG. 2). Similarly, the plurality of jaws 123 provide the phase C power line signal across the blades 222b and 224b of the second current coil 218b (see FIG. 2). Referring to FIG. 3, the phase A current flows from the blade 224a through the first current coil 218a to the blade 222a. The first current coil 218a imposes a scaled version of the current, referred to herein as the phase A current measurement signal, on the first current transformer 216a. The phase A current measurement signal is approximately equal to the current flowing through the current coil 218a scaled by a factor of N1, where N1 is the turns ratio of the current transformer 216a. The phase A current measurement signal is provided to the sockets 230a and 230b. The first current coil 218a is further operably connected to provide the phase A voltage to the socket 230c.

Similar to the phase A current, the phase C current flows from the blade 224b of the second current coil 218b to the blade 222b. The phase C current is imposed onto the second current transformer 216b, thereby causing the second current transformer 216b to generate a phase C current measurement signal. The phase C current measurement signal is approximately equal to the phase C current scaled by a factor of N2, where N2 is the turns ratio of the second current transformer 216b. The turns ratios N1 and N2 of the current transformers 216a and 216b, respectively, are typically substantially similar and preferably equal. However, manufacturing tolerances may result in slight differences in the turns ratios N1 and N2. In any event, the second current transformer 216b provides the phase C current measurement signal to the sockets 230e and 230f. The second current coil 218b is also operably connected to the socket 230d for the purposes of providing the phase C voltage thereto. The neutral blade 220 provides a connection between the neutral power line and the socket 230g.

It is noted that potentially hazardous electrical signals reside on one or more of the sockets 230a through 230g. In particular, the sockets 230c and 230d provide a direct connection to the external or utility power line, and therefore are potentially extremely dangerous. Moreover, the sockets 230a, 230b, 230e, and 230f all include current measurement signals that are potentially dangerous to humans, depending somewhat on the overall power consumption of the facility being metered and the turns ratios N1 and N2. Accordingly, the relatively small physical size of the sockets 230a through 230g and their corresponding openings greatly inhibits and preferably prevents human contact with the socket connections.

Continuing with the general operation of the meter assembly 110, the sockets 230a and 230b (FIG. 3) provide the phase A current measurement signal to the plugs 240a and 240b, respectively, of the measurement meter 114 (FIG. 4). Likewise, the sockets 230e and 230f (FIG. 3) provide the phase C current measurement signal to the plugs 240e and 240f, respectively, of the measurement meter 114 (FIG. 4). The sockets 230c and 230d (FIG. 3), provide, respectively, the phase A and phase C voltage measurement signals to the plugs 240c and 240d (FIG. 4). The neutral socket 230g (FIG. 3) provides a neutral connection to the plug 240g of FIG. 4.

Referring again to FIG. 4, at least the basic metering functions are provided by the measurement circuit 142 within the measurement meter 114. It will be noted, however, that the “basic metering functions” of the measurement circuit 142 may include far more than simple energy measurement functions. For example, the basic metering functions provided by the measurement circuit 142 may include at least a part of one or more advanced features typically associated with electricity meters, such as time of use metering, load profiling, demand metering, as well as other features such as service type recognition, diagnostics, remote meter reading communications or the like.

In any event, the plugs 240a and 240b provide the phase A current measurement signal to the watt measurement IC 244 through the phase A current input circuit 312. The phase A current input circuit 312 preferably converts the phase A current measurement signal to a voltage signal having a magnitude and phase that is representative of the phase A current. The socket 240c provides the phase A voltage measurement signal through the phase A voltage input circuit 316 to the watt measurement IC 244.

The plugs 240e and 240f similarly provide the phase C current measurement signal to the watt measurement IC 244 through the phase C current input circuit 314. The phase C current input circuit 314 preferably converts the phase C current measurement signal to a voltage signal having a magnitude and phase that is representative of the phase C current. The socket 240d provides the phase C voltage measurement signal through the phase C voltage input circuit 318 to the watt measurement IC 244. The socket 240d further provides the phase C voltage to the power supply 260. The power supply 260 is further connected to the neutral plug 240g and operates to provide a bias voltage to each of the functional block circuits within the measurement meter 114.

The watt measurement IC 244 receives the phase A and phase C voltage and current measurement signals, and generates energy consumption data therefrom. To this end, the watt measurement IC 244 preferably samples, multiplies and accumulates the measurement signals as is known in the art to generate watt data, VA data, and/or VAR data. See, for example, U.S. Pat. No. 6,112,158 or U.S. Pat. No. 6,112,159, as discussed above, for a description of such operations.

The processor 248 then obtains watt data, VA data, and/or VAR data and further processes the data to provide energy consumption information in standard units in accordance with metering industry standards. The energy consumption information is communicated externally through the display 238. Alternatively or additionally, the energy consumption information may be communicated through an external communication circuit, not shown.

It is noted that in the exemplary embodiment described herein, the meter 10 is a type of meter commonly known in the industry as a self-contained meter. In a self-contained meter, the current coils of the meter, such as current coils 218a and 218b of the present invention, carry the entire current load of the electrical system. As a result, in a typical meter, if the meter is removed for repair or replacement, the current coils are removed from the jaws of the meter box, and power to the facility is interrupted. A distinct advantage of the present invention is that the measurement meter 114 may be removed for repair, replacement or upgrade without removing the current coils 218a and 218b. As a result, the facility experiences no electrical service interruption during the replacement.

The above-described meter assembly 110 of the present invention shown in FIGS. 1-4 allows a measurement meter having limited or no sensor circuitry to be removably coupled to a meter mounting device having a sensor circuit disposed therein. Such an arrangement allows for upgrade and repair of the measurement meter without replacing or disturbing most or all of the components of the sensor circuit. As a result, repair and/or upgrade of the metering function may be accomplished at reduced cost (by eliminating the unnecessary replacement of the sensor circuit components) and without interrupting the service to the customer. Moreover, the embodiment shown in FIGS. 1-4 may be retrofitted to existing, prior art meter mounting devices that do not include the sensor circuit.

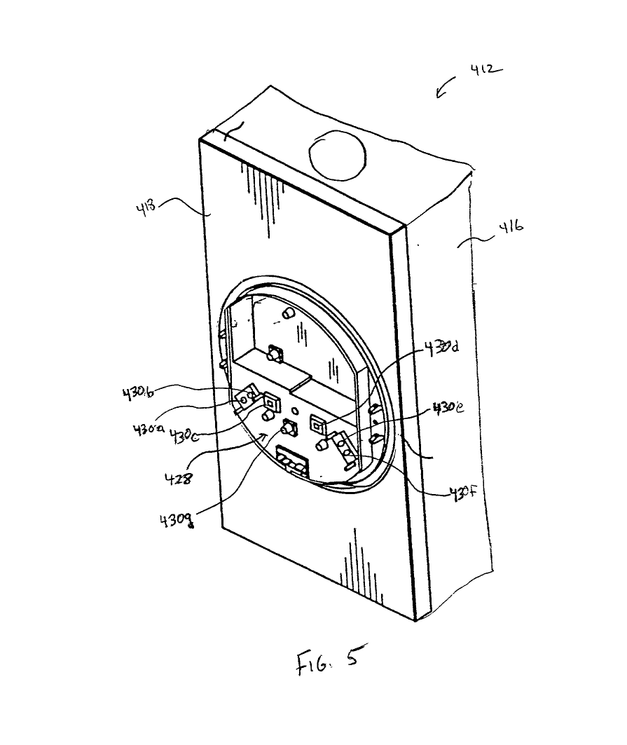

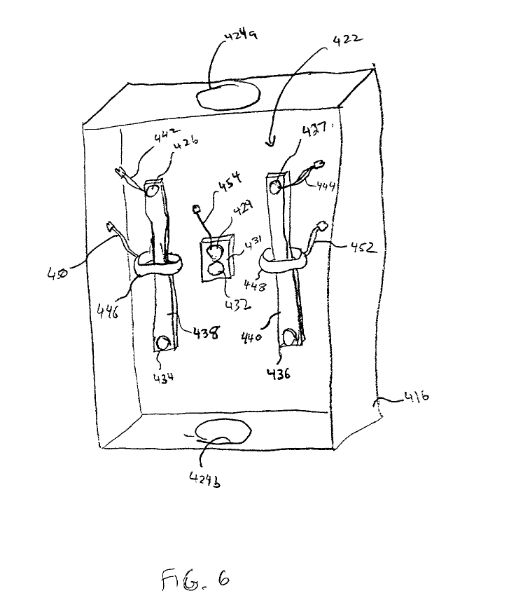

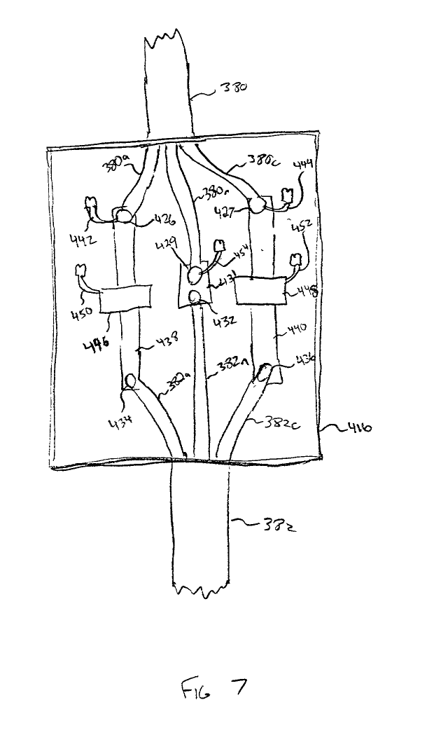

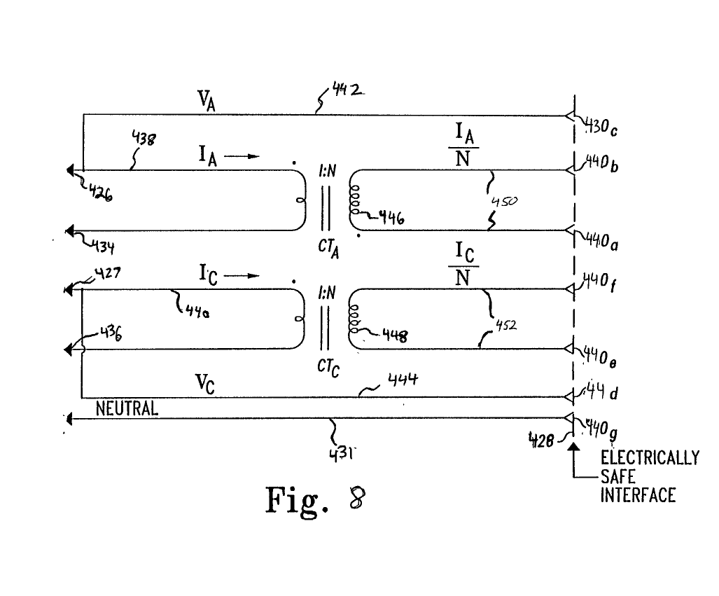

In an alternative embodiment the meter mounting device of the present invention inherently includes the sensor circuit, thus eliminating the need for the jaws 123 and the blades 222a, 222b, 224a, 224b, and 220. Such an embodiment is shown in FIGS. 5-8. In particular, FIG. 5 shows a front perspective view of a meter mounting device 412 according to a second embodiment of the present invention. FIG. 6 shows a front perspective view of an enclosure base 416 including the sensor circuit of the meter mounting device 412 of FIG. 5. FIG. 7 shows front plan view of the enclosure base 416 in an environment in which the sensor circuit is coupled to the power lines. FIG. 8 shows a schematic diagram of the sensor circuit of the meter mounting device.

Referring to FIG. 5, the meter mounting device 412 includes an interface 428 for receiving a measurement meter. The measurement meter may suitably be the measurement meter 114 of FIGS. 1-4. The interface 428 includes a plurality of sockets 430a, 430b, 430c, 430d, 430e, 430f and 430g. The interface 428 may suitably have the same general features as the electrically safe interface 126 of FIGS. 1-4, discussed above. The meter mounting device 412 further includes an enclosure base 416 and a cover 418. The interface 428 may be integrally formed with the cover, or may be secured thereto via mechanical or other methods.

FIGS. 6 and 7 show the enclosure base 416 with the cover 418 and interface 428 removed to illustrate the interior 422 of the meter mounting device 412. The enclosure base 416 includes a first cabling opening 424a located at a top portion of the enclosure base 416 and a second cabling opening 424b located at a bottom portion of the enclosure base 416. The first cabling opening 424a is configured to receive power lines 380 from the utility (see FIG. 7). The second cabling opening 424b is configured to receive power line feeders 382 from the load being metered (See FIG. 7). The configuration, location and number of cable openings are a matter of design choice.

Referring to FIG. 7, the power lines 380 include a phase A power line 380a, a phase C power line 380c, and a neutral line 380n. The power line feeders 382 include a phase A feeder 382a, a phase C feeder 382c, and a neutral feeder 382n. The power lines 380 connect to the electrical utility or other supplier of electricity, not shown. The feeder lines 382 connect to the load, for example, the electrical system of the facility that is purchasing electricity from the electrical utility.

Within the interior 422, the enclosure base 416 includes first and second power line terminals 426 and 427, respectively, first and second neutral terminals 429 and 432, respectively, and first and second feeder terminals 434 and 436, respectively. A first current conductor 438 electrically connects the first power line terminal 426 to the first feeder terminal 434. A second current conductor 440 electrically connects the second power line terminal 427 to the second feeder terminal 436.

The terminals 426, 427, 429, 432, 434 and 436 are configured to secure terminations of relatively thick power line and feeder wires. In particular, the terminal 426 is configured to provide a secure mechanical and electrical connection to the phase A power line 380a, the terminal 427 is configured to provide a secure mechanical and electrical connection to the phase C power line 380c, the terminal 429 is configured to provide a secure mechanical and electrical connection to the neutral line 380n, the terminal 432 is configured to provide a secure mechanical and electrical connection to the neutral feeder 382n, the terminal 434 is is configured to provide a secure mechanical and electrical connection to the phase A feeder 382a, and the terminal 436 is configured to provide a secure mechanical and electrical connection to the phase C feeder 382c.

To this end, the terminals 426, 427, 429, 432, 434 and 436 may suitably be screw terminals, with or without clamping mechanisms, or any other device well known in the art that provides such secure connections. Likewise, the conductors 438 and 440 may suitably be relatively thick wire conductors, conductive rigid bars, or other conductors capable of carrying relatively high currents. The conductors 438 and 440 may suitably be insulated or non-insulated. Such devices and their current carrying capacities would be known to those of ordinary skill in the art. The terminals 429 and 432 are also electrically connected, and may suitably be connected to a single conductive terminal block 431.

Accordingly, various types of terminals and conductors may be employed within the interior 422 of the meter mounting device 412. The present invention is in no way limited to the embodiment of those devices illustrated in FIGS. 6 and 7. What is important is that an electrical connection is made between the power lines 380 and the feeder 382 through the appropriate combinations of terminals and conductors. Nevertheless, in the exemplary embodiment illustrated in FIGS. 6 and 7, the current conductors 438 and 440 are conductive bars.

To connect the sensor elements to the interface 418, a number of leads are employed. Specifically, a first voltage lead 442 is electrically connected to the current conductor 438 either directly or through one of the terminals 426 and 434. The first voltage lead 442 is shown disconnected, but within the completed meter mounting device 412 is electrically connected to the socket 430c of the interface 428 (See FIG. 5). To this end, the first voltage lead 442 may suitably include a fasten type connector that connects to the socket 430c. In a similar manner, a second voltage lead 444 is electrically connected to the current conductor 440. As with the first voltage lead 442, the second voltage lead is shown disconnected, but within the completed meter mounting device is electrically connected to the socket 430d of the interface 428 (See FIG. 5). A neutral lead 454 extends from one of the terminals 429, 432, or from the block 431. The neutral lead 454 is configured to be coupled to the socket 430g of the interface 428.

The enclosure base 416 further includes first and second current transformers 446 and 448. Each of the first and second current transformers 446 and 448 is preferably a toroidal transformer similar to the transformer 216a of FIG. 2. The first current transformer 446 includes a two wire lead 450 that is configured to be coupled to the sockets 430a and 430b of the interface 428. The second current transformer 448 includes a two wire lead 452 that is configured to be coupled to the sockets 430e and 430f of the interface 428.

The first current transformer 446 is in a current sensing relationship with the first current conductor 438. To this end, the first current conductor 438 may suitably pass through the opening of the toroidal current transformer 446, as is known in the art. Likewise, the second current transformer 448 is in a current sensing relationship with the second current conductor 440. To this end, the second current conductor 440 may suitably pass through the opening of the toroidal current transformer 448.

The sensor circuit of the meter mounting device 412, comprising the current conductors 438 and 440, the current transformers 446 and 448 and their associated leads may readily be replaced by other voltage and current sensors. It is noted that the voltage sensor typically simply comprises a direct connection (leads 442 and 444) to the input power line voltage, which may be obtained from the current conductors 438 and 440, the terminals 426 and 427, or the terminals 434 and 436. However, other circuits that assist in delivering a voltage measurement signal representative of the voltage on the power lines 380 may suitably be used, including, by way of example, voltage dividers or voltage transformers. Alternative current sensors that may be used include embedded coils, such as those described in U.S. Pat. No. 5,343,143, and shunts.

It is noted that it is preferable to connect the voltage leads 442 and 444 at or near the terminal (e.g. terminals 426 and 427) at which the power lines 380 are connected. In this manner, the power consumed by the meter itself is not registered as power consumed by the subscriber.

In the operation of the meter mounting device 412, the phase A power line 380a is coupled to the terminal 426, the phase C power line 380c is coupled to the terminal 427, the phase A feeder 382a is coupled to the terminal 434, and the phase C feeder 382c is coupled to the terminal 436. (See FIG. 7). The neutral lines 380n and 382n are coupled to the terminals 429 and 432 respectively. So coupled, utility electrical power may flow from the power lines 380 to the load via the feeders 382. Because the power is delivered through the conductors 438 and 440, the power consumed may be metered thereby. In addition to the power line and feeder connections described above, the leads 442, 444, 450, 452 and 454 are coupled to the plugs 230a through 230g of the interface 428 as described above.

In metering operations, a measurement meter, which may suitably be the measurement meter 114 of FIGS. 2 and 4 described above, is coupled to the interface 428. The measurement meter in any event is a device operable to receive voltage and measurement signals from the meter mounting device 412 and generate energy consumption data therefrom. In the embodiment described herein, however, it will be assumed that the measurement meter 114 of FIGS. 2 and 4 is affixed to the meter mounting device 412.

To discuss the operation of the meter mounting device, reference will be made to FIG. 8, which shows a circuit diagram of the meter mounting device 412 assembled as described above. During normal operation, the phase A power line 380a provides the phase A power line signal, in other words, the phase A voltage and current, to the terminal 426. The phase A voltage and current propagates over the current conductor 438 to the terminal 434. The phase A voltage and current is then delivered to the load/customer over the phase A feeder 382a. (See FIGS. 7 and 8). Similarly, the phase C power line 380c provides the phase C power line signal to the terminal 427. The phase C power line signal (i.e. phase C voltage and current) propagates over the current conductor 440 to the terminal 436. The phase C power line signal is from there delivered to the load/customer over the phase C feeder 382c. (See FIGS. 7 and 8).

As the phase A current flows from the terminal 426 through the current conductor 438 to the terminal 434, the current conductor 438 imposes a scaled version of the current, referred to herein as the phase A current measurement signal, on the first current transformer 446. The phase A current measurement signal is approximately equal to the current flowing through the current conductor 438 scaled by a factor of N1, where N1 is the turns ratio of the current transformer 446. The two wire lead 450 provides the phase A current measurement signal to the sockets 430a and 430b. The lead 442 further provides the phase A voltage to the socket 430c.

Similar to the phase A current, the phase C current flows through the current conductor 440. As a result, the current conductor 440 imposes the phase C current is the second current transformer 448, thereby causing the second current transformer 448 to generate a phase C current measurement signal. The phase C current measurement signal is approximately equal to the phase C current scaled by a factor of N2, where N2 is the turns ratio of the second current transformer 448. The turns ratios N1 and N2 of the current transformers 446 and 448, respectively, are typically substantially similar and preferably equal. In any event, the second current transformer 448 provides the phase C current measurement signal to the sockets 430e and 430f via the two wire lead 452. The lead 444 also provides the phase C voltage to the socket 430d. The neutral lead 431 provides a connection between the neutral power line and the socket 430g.

It is noted that potentially hazardous electrical signals reside on one or more of the sockets 430a through 430g. In particular, the sockets 430c and 430d provide a direct connection to the external or utility power line, and therefore are potentially extremely dangerous. Moreover, the sockets 430a, 430b, 430e, and 430f all include current measurement signals that are potentially dangerous to humans, depending somewhat on the overall power consumption of the facility being metered and the turns ratios N1 and N2. Accordingly, the relatively small physical size of the sockets 430a through 430g and their corresponding openings greatly inhibits and preferably prevents human contact with the socket connections.

Continuing with the general operation of the meter mounting device 412, the sockets 430a through 430g provide their respective voltage and current measurement signals to corresponding connectors or plugs of a cooperating measurement meter. The measurement meter thereafter generates energy consumption data using any of a plurality of techniques well known in the art.

In the exemplary operation described herein, the measurement meter is the measurement meter 114 of FIGS. 2 and 4. Accordingly, the sockets 430a and 430b (FIG. 8) provide the phase A current measurement signal to the plugs 240a and 240b, respectively, of the measurement meter 114 (FIG. 4). Likewise, the sockets 430e and 430f (FIG. 8) provide the phase C current measurement signal to the plugs 240e and 240f, respectively, of the measurement meter 114 (FIG. 4). The sockets 430c and 430d (FIG. 8), provide, respectively, the phase A and phase C voltage measurement signals to the plugs 240c and 240d (FIG. 4). The neutral socket 430g (FIG. 8) provides a neutral connection to the plug 240g of FIG. 4.

The measurement meter 114 may thereafter operate as described above in connection with FIG. 4. To this end, it will be appreciated that the meter mounting device 412 provides the same configuration of signals to the plugs 240a through 240g as does the meter mounting device 110. As a result, the operations of the measurement meter 114 may be the same.

The embodiment of FIGS. 5-8 show a meter mounting device 412 that is preconfigured to include a sensor circuit therein. By contrast, the embodiment of the FIGS. 1-4 show a meter mounting device 112 that may constitute an existing meter box that is converted to become a meter mounting device that includes sensor circuitry. One advantage of the embodiment of FIGS. 5-8 is the elimination of jaws and blades, which add to the material cost of the metering assembly. Accordingly, one aspect of the invention described in FIGS. 5-8 is the reduced expense and increased reliability that results from employing a jawless connection between the sensor circuit and the utility power lines. By jawless, it is meant that the connection does not employ a jaw terminal, connected to the power line, that receives corresponding blades of the sensor circuit in the manner typically used by meter arrangements. A jaw terminal and corresponding blade arrangement is exemplified by the jaws 123 of FIG. 1 and the blades 222a, 222b, 224a, and 224b of FIG. 2.

Both embodiments allow for relatively inexpensive and safe replacement of the electronic functionality of the meter. With the expanding feature set available in meters, replacement of the electronic functionality of meters is of growing importance. By incorporate the sensor circuitry into the meter mounting device, the present invention allows the utility (or other person) to readily upgrade or replace the functionality without the undesirable expense associated with replacing the sensor circuitry.

It will be understood that the above embodiments are merely exemplary, and that those of ordinary skill in the art may readily devise their own implementations that incorporate the principles of the present invention and fall within the spirit and scope thereof. For example, while the meter 114 includes a display 238, other devices for communicating energy consumption data may alternatively be employed, such as serial or parallel communication lines to an external computer or module, on-board printing devices, and audible communication devices.

Moreover, the present invention is in no way limited to meters that utilize current transformers and current coils as voltage and current sensing means. The principles and advantages of the present invention are readily incorporated into meters utilizing voltage and current sensing means that include current shunt sensing devices, inductive current pick-up devices, Hall-effect current sensors, and other well-known voltage and current sensing devices.

What is claimed:

1. An electricity meter assembly comprising:
a) a meter mounting device operable to receive power lines of a load being metered, the meter mounting device including a sensor circuit operably connected to the power lines, the sensor circuit operable to generate measurement signals representative of voltage and current signals on the power lines;
b) a measurement meter including a measurement circuit operable to receive measurement signals and generate energy consumption data therefrom, said measurement meter including a device that communicates information relating to the energy consumption data, said measurement meter operable to be removably coupled to the meter mounting device such that the measurement circuit is operably connected to the sensor circuit to received the measurement signals when the measurement meter is coupled to the meter mounting device.

2. The electricity meter of claim 1 wherein the meter mounting device includes an enclosure that defines an interior, and wherein the power lines are received into the interior and the sensor circuit is disposed within the interior.

3. The electricity meter of claim 2 wherein the sensor circuit is operably connected to the power lines using jawless connections.

4. The electricity meter of claim 1 wherein the sensor circuit is operably connected to the power lines using jawless connections.

5. The electricity meter of claim 4 wherein the meter mounting device includes an electrically safe interface, and wherein the measurement meter is removably coupled to the meter mounting device via the electrically safe interface.

6. The electricity meter of claim 1 wherein the meter mounting device includes an electrically safe interface, and wherein the measurement meter is removably coupled to the meter mounting device via the electrically safe interface.

7. The electricity meter of claim 6 wherein the meter mounting device includes a plurality of sockets, and wherein the measurement meter includes a plurality of plugs configured to be received by the plurality of sockets.

8. A meter mounting device for use in connection with a measurement meter, the measurement meter including a measurement circuit operable to receive measurement signals and generate energy consumption data therefrom, the meter mounting device operable to receive power lines of a load being metered, the meter mounting device including a sensor circuit operably connected to the power lines, the sensor circuit operable to generate the measurement signals, the measurement signals representative of voltage and current signals on the power lines, the meter mounting device configured to allow the measurement meter to be removably coupled thereto such that the measurement circuit is operable receive measurement signals from the sensor circuit when the measurement meter is coupled to the meter mounting device.

9. The meter mounting device of claim 8 further comprising an enclosure that defines an interior, and wherein the power lines are received into the interior and the sensor circuit is disposed within the interior.

10. The meter mounting device of claim 9 wherein the sensor circuit is operably connected to the power lines using jawless connections.

11. The meter mounting device of claim 8 wherein the sensor circuit is operably connected to the power lines using jawless connections.

12. The meter mounting device of claim 8 further comprising an electrically safe interface for receiving the measurement meter.

13. The meter mounting device of claim 12 wherein the electrically safe interface includes a plurality of sockets, and wherein the measurement meter includes a plurality of plugs configured to be received by the plurality of sockets.

14. The meter mounting device of claim 8 wherein the sensor circuit includes a conductor coupled to a power line operable to provide voltage measurement signals.

15. The meter mounting device of claim 8 wherein the sensor circuit includes a current transformer.

16. A meter mounting device for use in connection with a measurement meter, the measurement meter including a measurement circuit operable to receive measurement signals and generate energy consumption data therefrom, the meter mounting device having an enclosure forming an interior, the meter mounting device including at least one opening for receiving power lines of a load being metered, the meter mounting device including a sensor circuit having a jawless connection to the power lines, the sensor circuit operable to generate the measurement signals, the measurement signals representative of voltage and current signals on the power lines, the meter mounting device configured to allow the measurement meter to be removably coupled thereto such that the measurement circuit is operable receive measurement signals from the sensor circuit when the measurement meter is coupled to the meter mounting device.

17. The meter mounting device of claim 16 further comprising an electrically safe interface for receiving the measurement meter.

18. The meter mounting device of claim 17 wherein the electrically safe interface includes a plurality of sockets, and wherein the measurement meter includes a plurality of plugs configured to be received by the plurality of sockets.

19. The meter mounting device of claim 16 wherein the sensor circuit includes a conductor coupled to a power line operable to provide voltage measurement signals.

20. The meter mounting device of claim 8 wherein the sensor circuit includes a current transformer.
